(19) United States
(12) Patent Application Publication
(10) Pub. No.: US 2018/0232154 A1
(43) Pub. Date: Aug. 16, 2018

(54) Append Only Streams For Storing Data On A Solid State Device

(71) Applicant: Microsoft Technology Licensing, LLC, Redmond, WA (US)

(72) Inventors: Bryan S. MATTHEW, Redmond, WA (US); Srinivasan MALAYALA, Redmond, WA (US); Aaron W. OGUS, Redmond, WA (US); Vadim MAKHERVAKS, Redmond, WA (US); Laura M. CAULFIELD, Redmond, WA (US); Rajsekhar DAS, Redmond, WA (US); Erik M. SCHMIDT, Redmond, WA (US); JR TIPTON, Redmond, WA (US); Tristan C. GRIFFITH, Redmond, WA (US); Chesong LEE, Redmond, WA (US); Scott C. LEE, Redmond, WA (US)

(21) Appl. No.: 15/898,083

(22) Filed: Feb. 15, 2018

Related U.S. Application Data
(63) Continuation-in-part of application No. 15/628,994, filed on Jun. 21, 2017.
(60) Provisional application No. 62/459,426, filed on Feb. 15, 2017.

(51) Int. Cl. G06F 3/06

(52) U.S. Cl. CPC G06F 3/0608; G06F 3/0635; G06F 3/0688; G06F 3/0652; G06F 3/064

(57) ABSTRACT

Streaming functionality may be utilized for optimizing the storage of data on a solid state device. In one embodiment, an append-only streaming method may comprise determining a size of one or more related groups of data, determining a size of one or more erase blocks in a file system, requesting from the file system one or more stream identifiers based on the size of the one or more related groups of data and the size of the one or more erase blocks, requesting from a solid state device and using the one or more stream identifiers an optimal writable space on the solid state device, and writing data to the optimal writable space on the solid state device.

### CROSS REFERENCE TO RELATED APPLICATIONS

This application is a continuation-in-part of U.S. patent application Ser. No. 15/628,994, filed on Jun. 21, 2017 and titled “Opportunistic Use of Streams for Storing Data on a Solid State Device,” which claims the benefit of U.S. provisional application No. 62/459,426 filed on Feb. 15, 2017, both of which are incorporated herein by reference in their entirety.

### BACKGROUND

Solid state devices (SSDs), such as flash storage, offer benefits over traditional hard disk drives (HDDs). For example, SSDs are often faster, quieter and draw less power than their HDD counterparts. However, there are also drawbacks associated with SSDs. For example, SSDs are limited in the sense that data can only be erased from the storage device in blocks, also known as “erase blocks.” These blocks may contain, in addition to data that a user wishes to erase, important data that the user wishes to keep stored on the SSD. In order to erase the unwanted data, the SSD must perform a process known as “garbage collection” in order to move data around on the SSD so that important files are not accidentally deleted. However, this process may result in an effect known as “write amplification” where the same data is written to the physical media on the SSD multiple times, shortening the lifespan of the SSD. Streaming is a process by which data stored on the SSD may be grouped together in a stream comprising one or more erase blocks based, for example, on an estimated deletion time of all of the data in the stream. By storing data that is likely to be deleted together in the same erase block or group of erase blocks (i.e., the same stream), a number of the problems associated with SSD storage may be alleviated.

### SUMMARY

Methods and systems are disclosed for optimizing the use of streams for storing data on a solid state device. In a first embodiment, a random-access streaming method may comprise writing data associated with a plurality of files to a first set of one or more erase blocks not associated with a stream, determining that an amount of data associated with a given one of the plurality of files in the first set of one or more erase blocks has reached a threshold, and moving the data associated with the given file from the first set of one or more erase blocks to a stream, the stream comprising a second set of one or more erase blocks different from the first set of one or more erase blocks, the first set of one or more erase blocks and the second set of one or more erase blocks being located on a storage device.

In a second embodiment, an append-only streaming method may comprise determining a size of one or more related groups of data, determining a size of one or more erase blocks in a file system, requesting from the file system one or more stream identifiers based on the size of the one or more related groups of data and the size of the one or more erase blocks, requesting from a solid state device and using the one or more stream identifiers an optimal writable space on the solid state device, and writing data to the optimal writable space on the solid state device.

### BRIEF DESCRIPTION OF THE DRAWINGS

The foregoing Summary, as well as the following Detailed Description, is better understood when read in conjunction with the appended drawings. In order to illustrate the present disclosure, various aspects of the disclosure are shown. However, the disclosure is not limited to the specific aspects discussed. In the drawings:

FIG. 1 illustrates an example computing device, in which the aspects disclosed herein may be employed;

FIG. 2 illustrates an example solid state device (SSD);

FIGS. 3A-3D illustrate a process of garbage collection performed on the SSD;

FIG. 4 illustrates a process of streaming multiple erase blocks on a device, for example, on an SSD;

FIG. 5 illustrates an example architecture for implementing streaming functionality on a device;

FIG. 6 illustrates an example method for optimizing the use of available streams on a storage device;

FIG. 7 illustrates a method of writing data associated with a number of files to an erase block in a non-stream manner;

FIG. 8 illustrates the continued writing data associated with a number of files to a second erase block in a non-stream manner;

FIG. 9 illustrates a method of moving the data associated with a given file from a group of one or more erase blocks to a stream;

FIG. 10 illustrates a method of writing additional data associated with the given file to the stream;

FIG. 11 illustrates a method of writing data associated with the given file in a non-stream manner in response to a determination that the stream is full;

FIG. 12 illustrates a file system implementing the method for optimizing the use of available streams on the storage device;

FIG. 13 illustrates a storage device implementing the method for optimizing the use of available streams on the storage device;

FIG. 14 illustrates a high-level workflow in append-only streams from the host perspective;

FIG. 15 illustrates a flow chart of an example append-only write operation;

FIG. 16 illustrates a first example workflow for allocating a new data extent;

FIG. 17 illustrates a second example workflow for allocating a new data extent;

FIG. 18 illustrates a first example workflow for writing to an open data extent; and

FIG. 19 illustrates a second example workflow for writing to an open data extent.

### DETAILED DESCRIPTION

Disclosed herein are methods and systems for optimizing the number of stream writes to a storage device based, for example, on an amount of data associated with a given file and a size of available streams on the storage device. For example, a method may comprise writing data associated with a plurality of files to a first set of one or more erase blocks, determining that an amount of data associated with a given one of the plurality of files in the first set of one or more erase blocks has reached a threshold, and moving the data associated with the given file from the first set of one or more erase blocks to a stream, the stream comprising a second set of one or more erase blocks on the storage device different from the first set of one or more erase blocks.

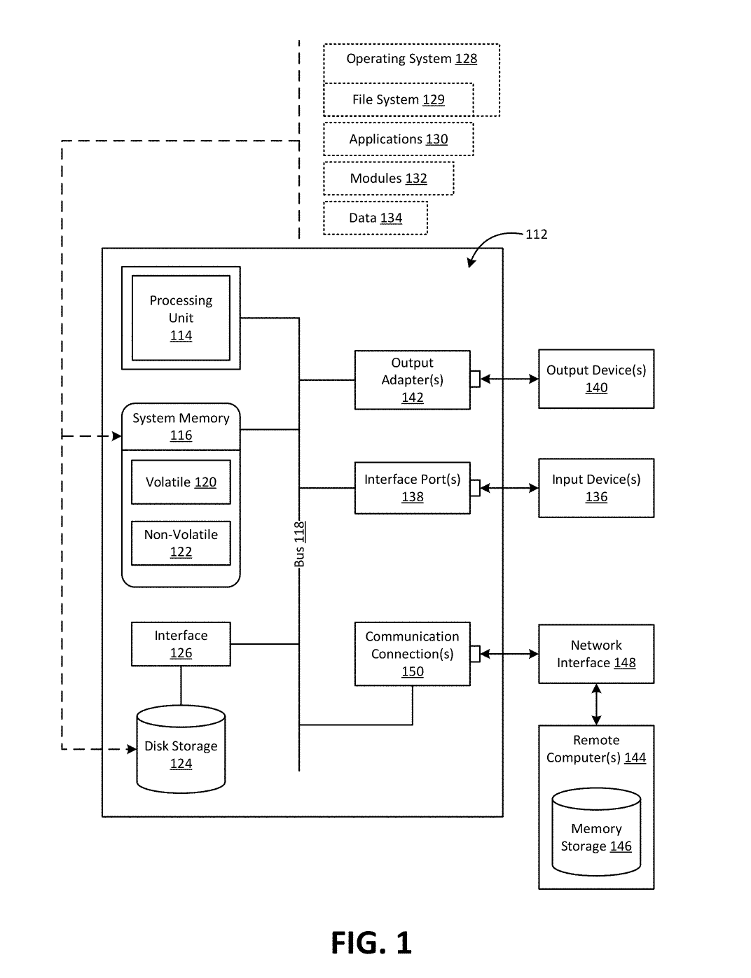

FIG. 1 illustrates an example computing device 112 in which the techniques and solutions disclosed herein may be implemented or embodied. The computing device 112 may be any one of a variety of different types of computing devices, including, but not limited to, a computer, personal computer, server, portable computer, mobile computer, wearable computer, laptop, tablet, personal digital assistant, smartphone, digital camera, or any other machine that performs computations automatically.

The computing device 112 includes a processing unit 114, a system memory 116, and a system bus 118. The system bus 118 couples system components including, but not limited to, the system memory 116 to the processing unit 114. The processing unit 114 may be any of various available processors. Dual microprocessors and other multiprocessor architectures also may be employed as the processing unit 114.

The system bus 118 may be any of several types of bus structure(s) including a memory bus or memory controller, a peripheral bus or external bus, and/or a local bus using any variety of available bus architectures including, but not limited to, Industry Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 116 includes volatile memory 120 and nonvolatile memory 122. The basic input/output system (BIOS), containing the basic routines to transfer information between elements within the computing device 112, such as during start-up, is stored in nonvolatile memory 122. By way of illustration, and not limitation, nonvolatile memory 122 may include read only memory (ROM), programmable ROM (PROM), electrically programmable ROM (EPROM), electrically erasable ROM (EEPROM), or flash memory. Volatile memory 120 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computing device 112 also may include removable/non-removable, volatile/non-volatile computer-readable storage media. FIG. 1 illustrates, for example, secondary storage 124. Secondary storage 124 includes, but is not limited to, devices like a magnetic disk drive, floppy disk drive, tape drive, Jaz drive, Zip drive, LS-100 drive, memory card (such as an SD memory card), or memory stick. In addition, secondary storage 124 may include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the secondary storage 124 to the system bus 118, a removable or non-removable interface is typically used such as interface 126.

FIG. 1 further depicts software that acts as an intermediary between users and the basic computer resources described in the computing device 112. Such software includes an operating system 128. Operating system 128, which may be stored on secondary storage 124, acts to control and allocate resources of the computing device 112. Applications 130 take advantage of the management of resources by operating system 128 through program modules 132 and program data 134 stored either in system memory 116 or on secondary storage 124. It is to be appreciated that the aspects described herein may be implemented with various operating systems or combinations of operating systems. As further shown, the operating system 128 includes a file system 129 for storing and organizing, on the secondary storage 124, computer files and the data they contain to make it easy to find and access them.

A user may enter commands or information into the computing device 112 through input device(s) 136. Input devices 136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 114 through the system bus 118 via interface port(s) 138. Interface port(s) 138 include, for example, a serial port, a parallel port, a game port, and a universal serial bus (USB). Output device(s) 140 use some of the same type of ports as input device(s) 136. Thus, for example, a USB port may be used to provide input to computing device 112, and to output information from computing device 112 to an output device 140. Output adapter 142 is provided to illustrate that there are some output devices 140 like monitors, speakers, and printers, among other output devices 140, which require special adapters. The output adapters 142 include, by way of illustration and not limitation, video and sound cards that provide a means of connection between the output device 140 and the system bus 118. It should be noted that other devices and/or systems of devices provide both input and output capabilities such as remote computer(s) 144.

Computing device 112 may operate in a networked environment using logical connections to one or more remote computing devices, such as remote computing device(s) 144. The remote computing device(s) 144 may be a personal computer, a server, a router, a network PC, a workstation, a microprocessor based appliance, a peer device, another computing device identical to the computing device 112, or the like, and typically includes many or all of the elements described relative to computing device 112. For purposes of brevity, only a memory storage device 146 is illustrated with remote computing device(s) 144. Remote computing device(s) 144 is logically connected to computing device 112 through a network interface 148 and then physically connected via communication connection 150. Network interface 148 encompasses communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 150 refers to the hardware/software employed to connect the network interface 148 to the bus 118. While communication connection 150 is shown for illustrative clarity inside computing device 112, it may also be external to computing device 112. The hardware/software necessary for connection to the network interface 148 includes, for exemplary purposes only, internal and external technologies such as modems including regular telephone grade modems, cable modems and DSL modems, ISDN adapters, and Ethernet cards.

As used herein, the terms “component,” “system,” “module,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/ or distributed between two or more computers.

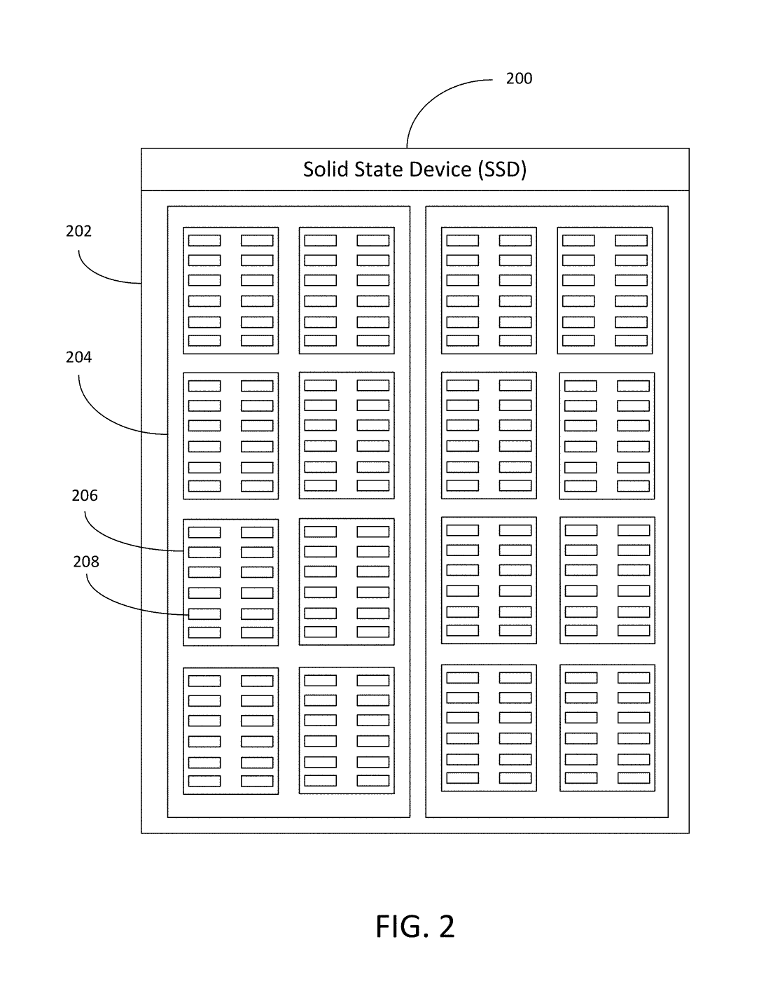

FIG. 2 illustrates an example solid state device (SSD) 200. The SSD illustrated in FIG. 2 may be, for example, a NAND flash storage device. The SSD 200 may, for example, be used to implement the secondary storage 124 of the example computing device shown in FIG. 1. As shown, the SSD may comprise a die 202. A die may represent the smallest unit of the SSD that can independently execute commands. While the SSD in FIG. 2 comprises only a single die, it is understood that an SSD may comprise any number of die. As further shown in FIG. 2, each die may comprise one or more planes 204. An SSD may typically comprise one or two planes, and concurrent operations may take place on each plane. However, it is understood that an SSD may comprise any number of planes. As further illustrated in FIG. 2, each plane 204 may comprise a number of blocks 206. A block may be the smallest unit of the SSD that can be erased. Blocks may also be referred to herein as “erase blocks.” Finally, as shown in FIG. 2, each block 206 may comprise a number of pages 208. A page may be the smallest unit of the SSD that can be programmed.

Program operations on the SSD, also known as “writes” or “write operations,” may be made to any given page on the SSD. A page may be, for example, about 4-16 KB in size, although it is understood that any size may be used. In contrast, erase operations may be only be made at the block level. A block may be, for example, about 4-8 MB in size, although it is understood that any size may be used. A controller associated with the SSD may manage the flash memory and interface with the host system using a logical-to-physical mapping system, for example, logical block addressing (LBA).

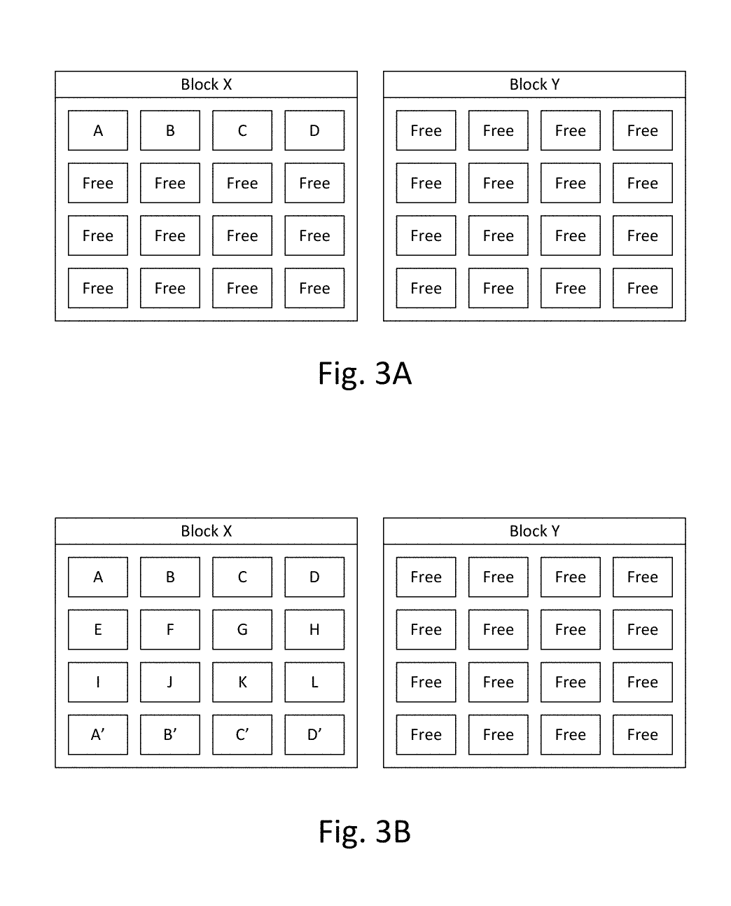

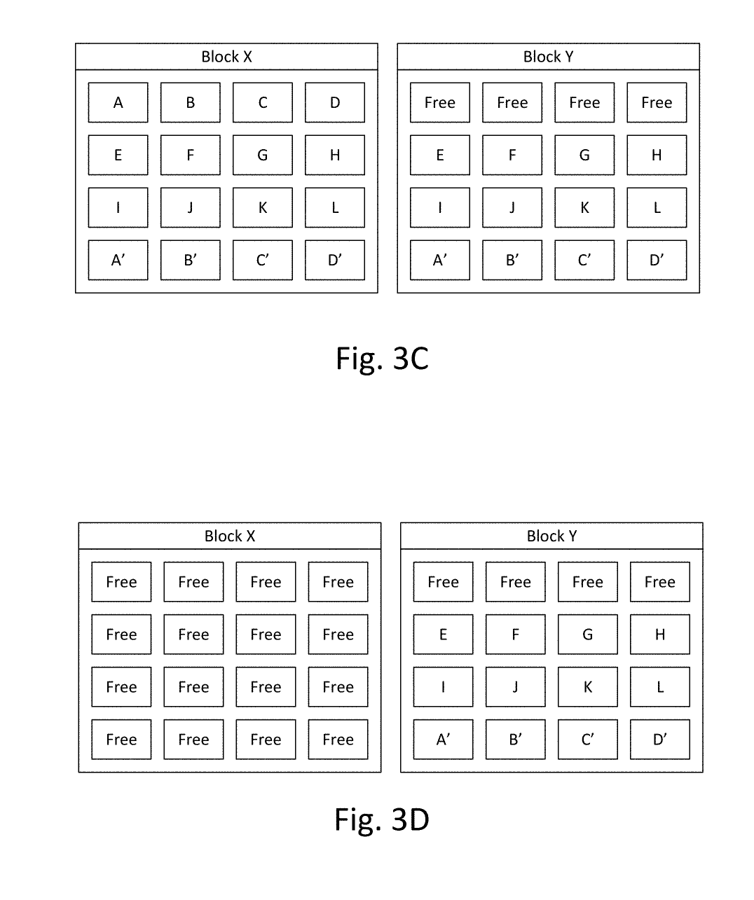

SSDs generally do not allow for data stored in a given page to be updated. When new or updated data is saved to the SSD, the controller may be configured to write the new or updated data in a new location on the SSD and to update the logical mapping to point to the new physical location. This new location may be, for example, a different page within the same erase block, as further illustrated in FIG. 3. At this point, the data in the old location may no longer be valid, and may need to be erased before the location can be written to again.

However, as discussed above, the old or invalid data may not be erased without erasing all of the data within the same erase block. For example, that erase block may contain the new or updated data, as well as other data that a user may wish to keep stored on the SSD. In order to address this issue, the controller may be configured to copy or re-write all of the data that is not intended to be deleted to new pages in a different erase block. This may be referred to herein as “garbage collection.” The new or updated data may be written directly to a new page or may be striped across a number of pages in the new erase block. This undesirable process by which data is written to the SSD multiple times as a result of the SSDs inability to update data is known as write amplification, and is further illustrated below in connection with FIG. 3. Write amplification presents a significant problem in SSD storage as SSDs can only be programmed and erased a limited number of times. This may be referred to herein as the number of program/erase cycles that the SSD can sustain.

As shown in FIG. 3A, an SSD may comprise two blocks: Block X and Block Y. It is understood that while the SSD illustrated in FIGS. 3A-3D comprises two blocks, an SSD may comprise any number of blocks. As discussed above, a block or “erase block” may comprise the smallest unit of the SSD that may be erased. Each of Block X and Block Y illustrated in FIGS. 3A-3D comprises sixteen pages, however, it is understood that a given block may comprise any number of pages. Data may be written directly to any one of the pages on Block X or Block Y. In addition, data may be striped across a plurality of pages associated with Block X or Block Y. As shown in FIG. 3A, data may be written to Page A, Page B, Page C and Page D associated with Block X, while the remaining pages of Block X may be left empty (free). Block Y may similarly be left empty.

As shown in FIG. 3B, additional data may be written to Block X at a later time via a write operation by the controller. Again, this write operation may comprise writing data directly to any one of the pages in Block X or Block Y or striping the data across a plurality of the pages. For example, data may be written directly to or striped across Page E, Page F, Page G, Page H, Page I, Page J, Page K and Page L associated with Block X. In addition, a user or application may wish to update the information stored at Pages A-D of FIG. 3A. However, as discussed above, the SSD may not allow for data to be updated. Thus, in order to store the new data, a controller associated with the SSD may be configured to execute a write operation to additional pages in Block X representing the updates to Pages A-D. These pages, as illustrated in FIG. 3B, may be labeled as Page A′, Page B′, Page C′ and Page D′. The data stored at Pages A′-D′ may represent any of minor or major updates to the data stored at Pages A-D.

As further illustrated in FIG. 3C, in order to perform a delete operation on the data stored at Pages A-D, and as further discussed above, the entirety of Block X may need to be erased. The controller associated with the SSD may be configured to copy or re-write important data on Block X that the user does not wish to be deleted to a different erase block, for example, Block Y. As illustrated in FIG. 3C, the controller may be configured to copy the data stored at Pages E-L as well as the data stored at Pages A′-D′ of Block X to Block Y.

As discussed above, this process of “updating” data to a new location may be referred to “garbage collection.” The process of garbage collection as illustrated in FIG. 3C may address the issue of erasing unwanted data while keeping important data stored on the device. However, this comes at the cost of copying and re-writing a single piece of data multiple times on the same SSD. For example, both Block X and Block Y of the SSD may contain copies of the data stored at Pages E-L as well as the data stored at Pages A′-D′. This undesirable process of re-writing multiple copies of the same data may be known as write amplification.

Finally, as shown in FIG. 3D, the controller may be configured to erase all of the data stored at Block X. As all of the important data intended to be kept on the SSD has been copied to Block Y, the entirety of Block X may be deleted by the controller. Once this process has completed, the controller may be configured to write new data to any of the pages in Block X. However, as discussed above, this process of write amplification presents a significant problem in SSD storage as an SSD may only be programmed and erased a limited number of times. For example, in the case of a single level flash, the SSD may be written to and erased a maximum of 50,000-100,000 times.

One additional feature associated with SSD storage is the over-provisioning of storage space. Over-provisioning may be represented as the difference between the physical capacity of the flash memory and the logical capacity presented through the operating system as available for the user. During, for example, the process of garbage collection, the additional space from over-provisioning may help lower the write amplification when the controller writes to the flash memory. The controller may use this additional space to keep track of non-operating system data such as, for example, block status flags. Over-provisioning may provide reduced write amplification, increased endurance and increased performance of the SSD. However, this comes at the cost of less space being available to the user of the SSD for storage operations.

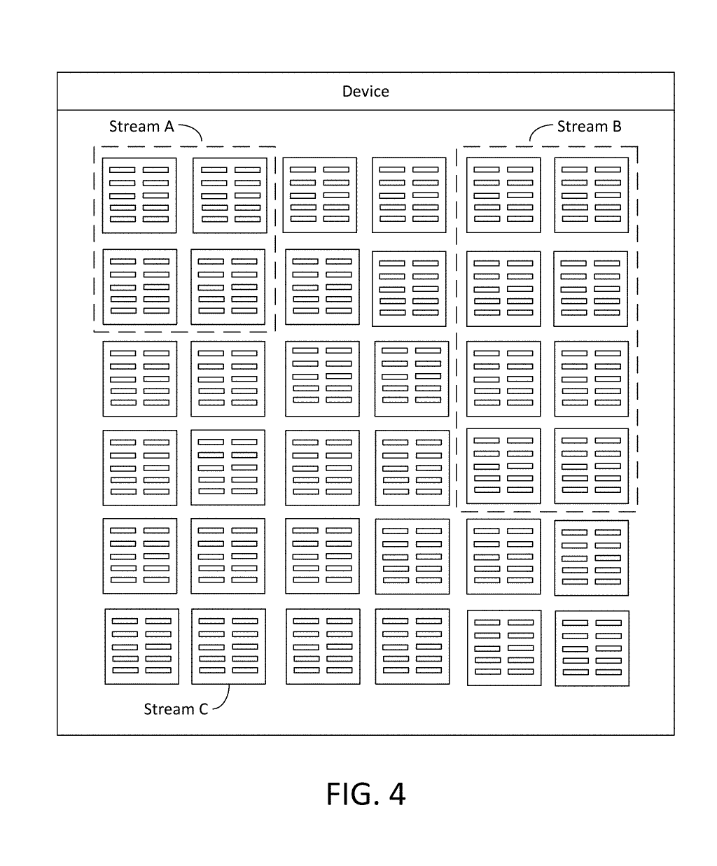

Solid state devices may support functionality known as “streaming” by which data may be associated with a particular stream based, for example, on an estimated deletion time of the data, in order to reduce the problems associated with write amplification and over-provisioning. A stream, as discussed herein, may comprise one or more erase blocks. The process of streaming SSDs may comprise, for example, instructing the SSD to associate a bunch of data together in the same erase block or group of erase blocks (i.e., in the same “stream”) because it is likely that all of the data will be erased at the same time. Because data that will be deleted together will be written to or striped across pages in the same erase block or group of erase blocks, the problems associated with write amplification and over-provisioning can be reduced. The process of streaming SSDs may be further illustrated as shown in connection with FIG. 4.

As shown in the example of FIG. 4, data may be grouped together in one or more erase blocks based, for example, on an estimated erase time of the data stored at each of the erase blocks. The controller may organize the one or more erase blocks such that data in each of the erase blocks may be erased together. This organization of data into one or more erase blocks based, for example, on an estimated deletion time of the data in the one or more erase blocks, may be referred to herein as “streaming.” As shown in FIG. 4, four erase blocks may be associated with Stream A, eight erase blocks may be associated with Stream B, and a single erase block may be associated with Stream C. The controller may be configured, for example, to perform all write operations of data that may be erased within two months to Stream A, all write operations of data that may be erased within two weeks to Stream B, and all write operations of data that may be erased within two days to Stream C. In another example, the controller may be configured to perform write operations to Stream A that may be erased upon the occurrence of an event that would result in all of the data written to Stream A being “updated” and subsequently marked as invalid.

A file system and a storage driver associated with a computing device may be provided with awareness of the “streaming” capability of an SSD in order to enable the file system and/or an application to take advantage of the streaming capability for more efficient storage. For example, a file system may be configured to receive a first request from an application to associate a file with a particular stream identifier available on a storage device, intercept one or more subsequent requests to write data to the file, associate the one or more subsequent requests with the stream identifier, and instruct a storage driver associated with the storage device to write the requested data to the identified stream. The file system may be further configured to store metadata associated with the file, the metadata comprising the stream identifier associated with the file. In addition, the file system may be configured to send to the application a plurality of stream parameters associated with the stream. The file system may be further configured, prior to associating the file with the stream identifier, to validate the stream identifier.

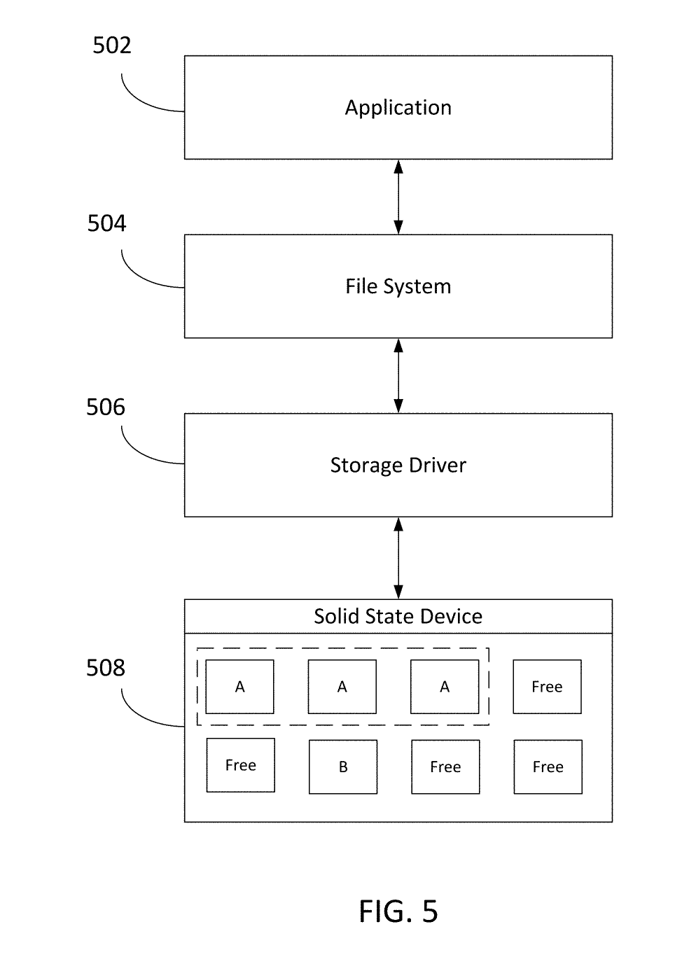

FIG. 5 is a block diagram illustrating example components of an architecture for implementing the streaming SSD functionality disclosed herein. As shown, in one embodiment, the architecture may comprise an application 502, a file system 504, a storage driver 506, and a storage device 508.

The application 502 may be configured to read and write files to the device 508 by communicating with the file system 504, and the file system 504 may, in turn, communicate with the storage driver 506. In order to take advantage of writing to a stream on the SSD, the application 502 may instruct the file system which ID to associate with a given file. The application 502 may be configured to instruct the file system which ID goes with the given file based, for example, on a determination that all of the data of the file may be deleted at the same time. In one embodiment, multiple erase blocks may be tagged with a particular stream ID. For example, using the device illustrated in FIG. 5, multiple erase blocks may be associated with Stream A, and data may be written directly to a given one of the erase blocks or striped across multiple pages associated with the erase blocks in Stream A. As another example, Stream B may comprise a single erase block, and data may be written to a given one of the pages or striped across multiple pages associated with the erase block associated with Stream B. The data associated with Stream A may have a different estimated deletion time than the data associated with Stream B.

The file system 504 may be configured to expose an application programming interface (API) to the application 502. For example, the application 502, via an API provided by the file system 504, may be configured to tag a file with a particular stream ID. In addition, the application 502, via an API provided by the file system 504, may be configured to perform stream management, such as, for example, determining how many streams can be written to simultaneously, what stream IDs are available, and the ability to close a given stream. Further, the application 502, via an API provided by the file system 504, may be configured to determine a number of parameters associated with the stream such as, for example, the optimal write size associated with the stream.

The file system 504 may be further configured to intercept a write operation by the application 502 to a file in the device 508, determine that the file is associated with a particular stream ID, and to tag the write operation (i.e., I/O call) with the stream ID. The file system 504 may be further configured to store metadata associated with each file of the device 508, and to further store the particular stream ID associated with each file along with the file metadata.

The storage driver 506 may be configured to expose an API to the file system 504. For example, the file system 504, via an API provided by the storage driver 506, may be configured to enable stream functionality on the storage device 508. The file system 504, via an API provided by the storage driver 506, may be further configured to discover existing streams on the device 508. The file system 504, via an API provided by the storage driver 506, may be further configured to obtain information from the device such as, for example, the ability of the device to support streams and what streams, if any, are currently open on the device. The storage driver 506 may be configured to communicate with the device 508 and to expose protocol device agnostic interfaces to the file system 504 so that the storage driver 506 may communicate with the device 508 without the file system 504 knowing the details of the particular device.

The device 508 may comprise, for example, an SSD. The SSD illustrated in FIG. 5, for example, comprises eight erase blocks. Data may be written individually to a given erase block or may be striped across a plurality of the erase blocks in order to maximize throughput on the SSD. As also shown in 508, and as further discussed herein, the plurality of erase blocks may be organized into streams such that data can be erased in a more efficient manner, as described above. For example, the SSD illustrated in FIG. 5 comprises Stream A which is associated with three erase blocks and Stream B which is associated with a single erase block.

As discussed herein, streaming is a process by which data stored on an SSD may be grouped together in a stream comprising one or more erase blocks based, for example, on an estimated deletion time of all of the data in the stream. By storing data that is likely to be deleted together in the same erase block or group of erase blocks, numerous problems associated with SSD storage can be alleviated. However, the number of streams available on a given SSD may be limited. In some cases, the size of a given stream may be much larger than the amount data stored for a particular file, and assigning that to an individual stream may result in inefficient use of the streaming functionality offered by the SSD. Thus, it may be desirable to perform a combination of stream and non-stream writes for data associated with particular files based, for example, on the amount of data stored for the particular file and a size of each available stream block.

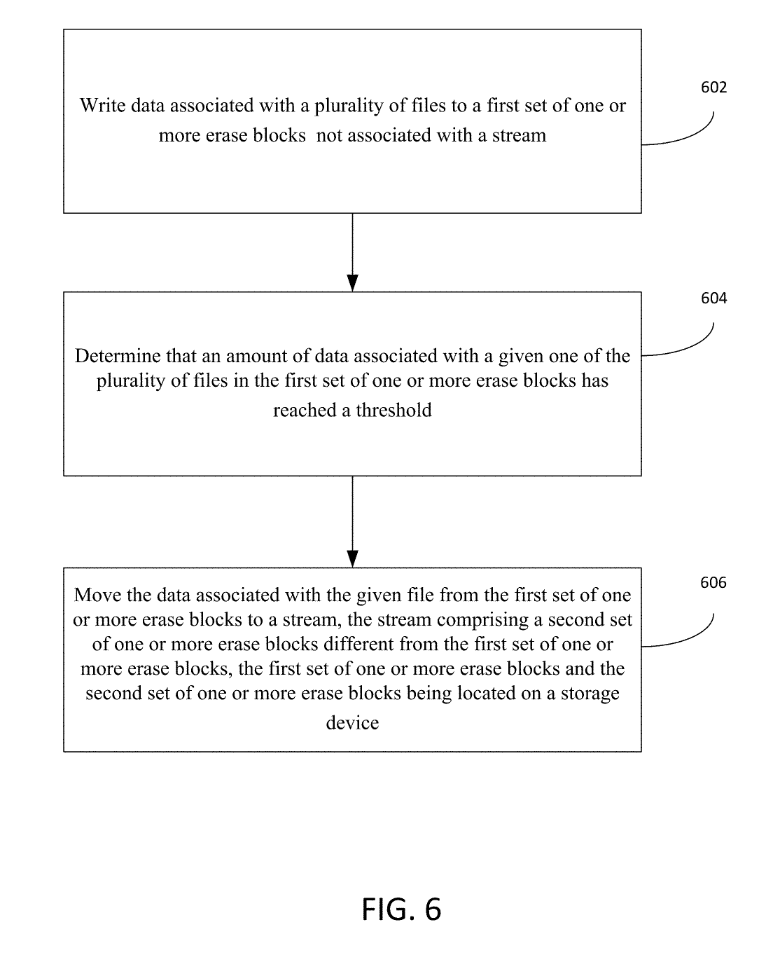

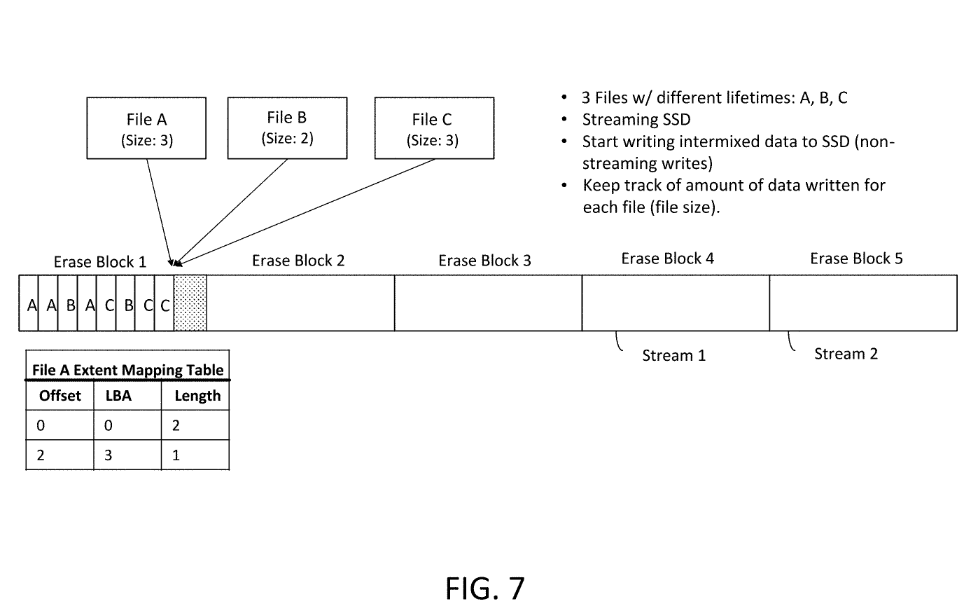

An example method for optimizing the use of streams available on a storage device is illustrated in FIG. 6. For example, the method may comprise writing data associated with a plurality of files to a first set of one or more erase blocks not associated with a stream, determining that an amount of data associated with a given one of the plurality of files in the first set of one or more erase blocks has reached a threshold, and moving the data associated with the given file from the first set of one or more erase blocks to a stream, the stream comprising a second set of one or more erase blocks different from the first set of one or more erase blocks. The first set of one or more erase blocks and the second set of one or more erase blocks may be located on a storage device, such as SSD 508 illustrated in FIG. 5. FIGS. 7-11, discussed below, illustrate in further detail the process of using both stream and non-stream writes to optimize the use of available streams. It is understood that the steps illustrated in FIGS. 7-11 may be performed by any number of devices, including, for example, a file system associated with a computing device or the SSD comprising the one or more streams.

FIG. 7 illustrates a method of writing data associated with a plurality of files to a first set of one or more erase blocks on a storage device. As shown in FIG. 7, data associated with File A, File B and File C may be written to the first set of one or more erase blocks. The first set of one or more erase blocks may not be associated with a stream. A set of one or more erase blocks may comprise any number of erase blocks available on the storage device. In one example, the first set of one or more erase blocks may comprise all erase blocks on the storage device that are not associated with a stream. In another example, the first set of one or more erase blocks may comprise a subset of all erase blocks on the storage device that are not associated with a stream. In another example, the set of one or more erase blocks may comprise a single erase block. In another example, the first set of one or more erase blocks may comprise one or more erase blocks in a stream. As shown in the example of FIG. 7, data associated with File A, File B and File C may be written to erase block 1. The set of one or more erase blocks may also comprise erase block 2 and erase block 3. As also shown in the example of FIG. 7, erase block 4 may be associated with Stream 1 and erase block 5 may be associated with Stream 2. However, as discussed herein, a stream may comprise any number of erase blocks. Data from each of File A, File B and File C may be written to any of erase blocks 1, 2 or 3 as part of a non-stream write. Thus, it is understood that data from each of File A, File B and File C may have a different estimated erase time. For example, it may be estimated that data associated with File A may be deleted two weeks from the time of the write operation, data associated with File B may be deleted two months from the time of the write operation and data associated with File C may be deleted two years from the time of the write operation.

As further shown in FIG. 7, a file system may be configured to keep track of the amount of data written for each file. For example, the file system may be configured to store metadata associated with each of the files. In one embodiment, the file system may be configured to maintain metadata about a file and its location on the storage device. For example, the metadata may take the form of a file extent mapping table, defining the offset, logical block address (LBA) and length of all data associated with a given file, as discussed further below.

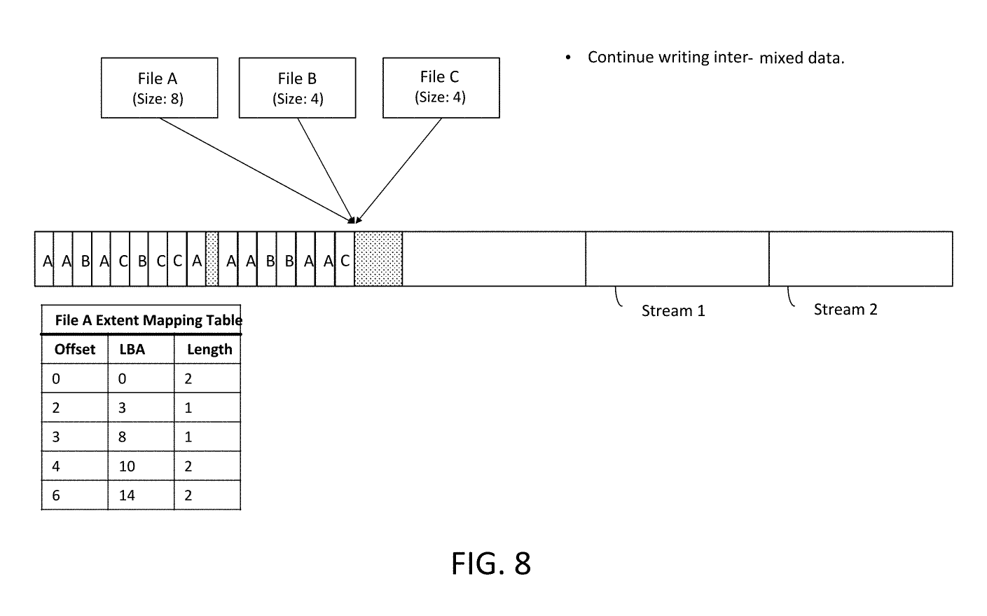

As shown in FIG. 8, data associated with each of File A, File B and File C may be continuously written to the first set of one or more erase blocks. In one embodiment, as erase block 1 reaches capacity, data associated with each of the files may be written to erase block 2. As data is continuously written for each of the files, it may be determined that an amount of data associated with a given one of the plurality of files in the first set of one or more erase blocks has reached a threshold. The threshold may be based on a storage capacity of one of more of the streams on the storage device. For example, a given stream may be able to store 256 MB of data. However, it is understood that the threshold may be based on any number of factors. For example, it could be possible that the application or some other entity residing on the computing device sends to the file system an indication that the file will soon be expanding in size and it would make sense to begin writing to a stream. In addition, metadata associated with the stream may define a threshold of, for example, 200 MB. The threshold may define the minimum amount of data that can be moved to the stream. Thus, when an amount of data associated with a given file in the first set of one or more erase blocks reaches 200 MB, data associated with the given file may be moved to a stream. It is understood that a stream may be of any size and that the threshold may be based on any number of metrics. It is further understood that a storage device may comprise multiple streams having different lengths, and that each of these streams may be associated with a different threshold.

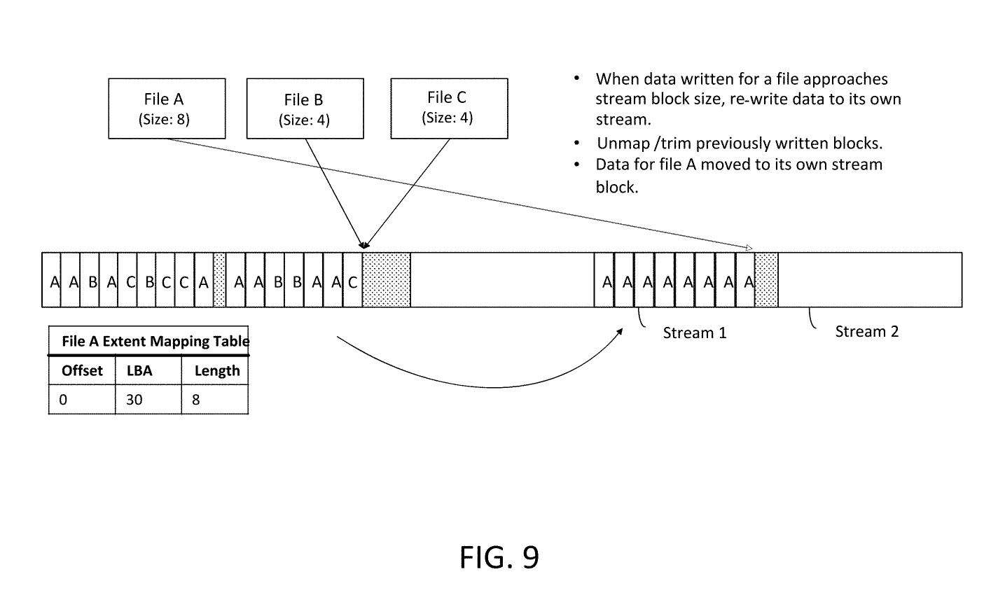

As shown in FIG. 9, once this threshold is reached, data associated with the given file may be moved from the first set of one or more erase blocks to a stream. The stream may comprise a second set of one or more erase blocks different from the first set of one or more erase blocks. As discussed herein, the stream may be used exclusively to store data of the given file. For example, as shown in FIG. 9, all of the data associated with File A in the first set of one or more erase blocks may be moved to Stream 1, Stream 1 being used exclusively to store data of File A. In the example that the first set of more erase are associated with a first stream, data may be moved from the first set of one or more erase blocks associated with the first stream to one or more erase blocks associated with a second stream, the first stream comprising data associated with a plurality of files and the second stream comprising data associated only with the given file. As also shown in FIG. 9, a trim operation may be performed on the data associated with the given file in the first set of one or more erase blocks. For example, a file system may be configured to instruct a storage device to execute a trim command on the data, thereby informing the storage device that the data inside the first set of one or more erase blocks is no longer in use and may be deleted. In response to receipt of the trim command, the storage device may be configured to “delete” the data associated with the given file in the first set of one or more erase blocks. As discussed herein, the storage device may need to perform garbage collection before the data can be permanently deleted.

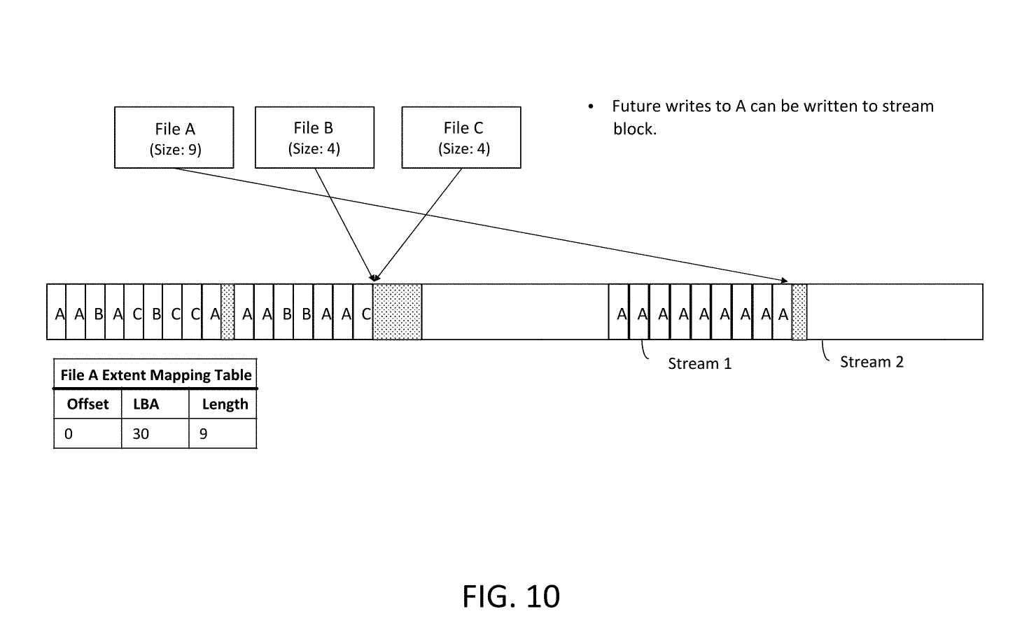

As shown in FIG. 10, data associated with the given file may be written to the stream. For example, data associated with File A may be continued to be written to Stream 2 until the amount of data in the stream has reached a second threshold, as discussed further below. A size of the stream may be stored as metadata. As shown in the example of FIG. 10, an additional write operation for File A has been made to Stream 1. As further shown in the example of FIG. 10, the amount of data in Stream 1 associated with File A may be approaching the capacity of the stream.

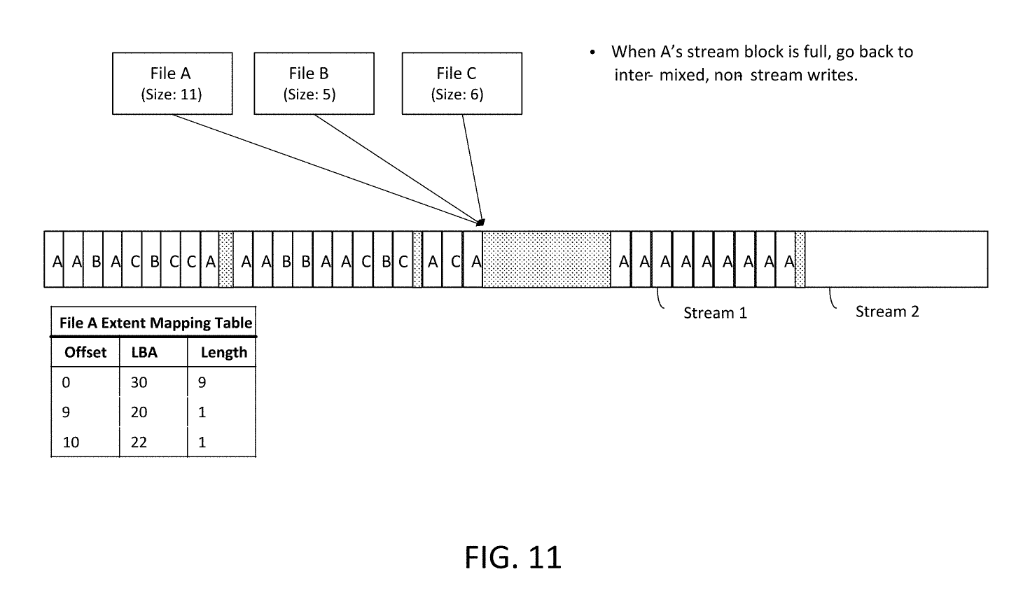

As shown in FIG. 11, in response to determining that the amount of data in the stream has reached a second threshold, the second threshold being based on a size of the stream, further data associated with the given file may again be written to the first set of one or more erase blocks. As shown in FIG. 11, the first set of one or more erase blocks may further comprise erase block 3 on the SSD. Erase block 3 may comprise, for example, data associated with File A and File C. However, it is understood that data may be written to any of the erase blocks on the storage device. For example, data associated with File A may be written to erase block 3 as well as any other available erase block on the SSD not associated with a stream. If at any point, data associated with a given one of the files has reached a predetermined threshold associated with an available stream on the storage device, the data may be moved to the stream comprising data exclusive to that file, as discussed herein.

In one example, the steps illustrated in FIGS. 7-11 may be performed by a file system associated with a computing device. This method may be referred to herein as a “host managed” method. This example method, discussed further below, may comprise moving the data associated with the given file from the first set of one or more erase blocks to local memory, and then sending, to the storage device, a request to write the data associated with the given file from the local memory to a stream on the storage device. The file system may then update metadata that it maintains for the file to reflect the change in location of the data on the storage device. In another example, the steps illustrated in FIGS. 7-11 may be performed by the storage device comprising the one or more streams. This method may be referred to herein as a “device managed” method. From the perspective of the storage device, this example method, discussed further below, may comprise receiving a stream identifier associated with the stream and a request to move the data associated with the given file from the first set of one or more erase blocks to the stream, copying the data associated with the given file from the first set of one or more erase blocks to the stream, and updating metadata maintained by the storage device to reflect the change in location of the data on the storage device.

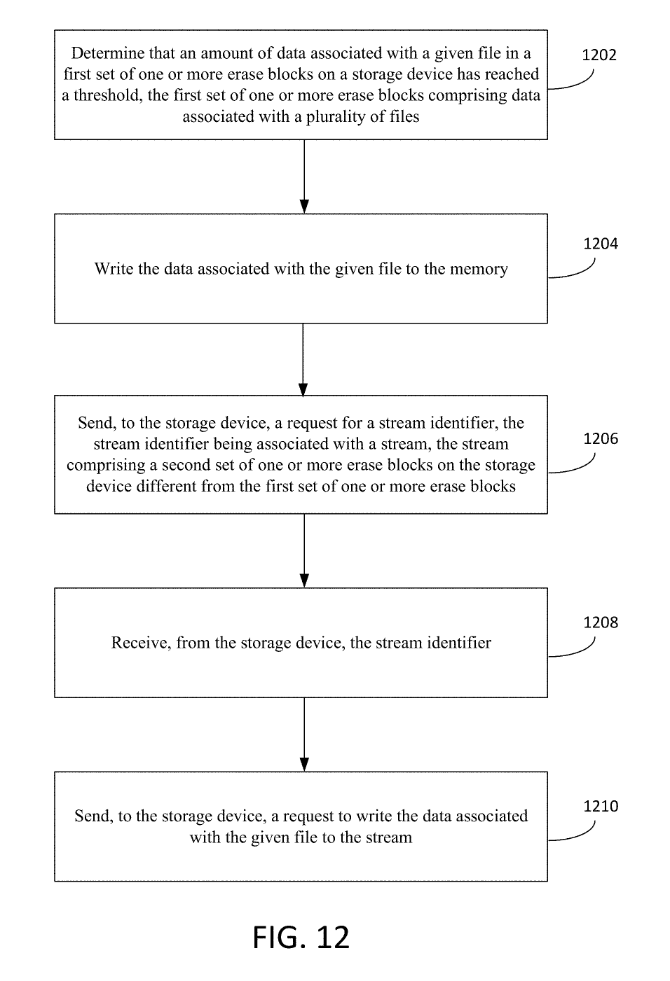

FIG. 12 illustrates an example method implemented by a file system to optimize the use of available streams on a storage device. This method may be referred to as “host managed.” As shown at step 1202 of FIG. 12, a file system may be configured to determine that an amount of data associated with a given file in a first set of one or more erase blocks has reached a threshold, the first set of one or more erase blocks comprising data associated with a plurality of files. The file system may be, for example, file system 504 illustrated in FIG. 5. The storage device may be, for example, the SSD 508 illustrated in FIG. 5. As discussed above in connection with FIGS. 7-11, data associated with a plurality of files may be written to the first set of one or more erase blocks. The first set of one or more erase blocks may correspond, for example, to a first erase block and a second erase block. The threshold may be based on a storage capacity of the one or more available streams on the storage device. For example, the file system 504 may determine that when data associated with the given file in the first set of one or more erase blocks reaches half of the maximum storage capacity of a given stream, to move the data associated with that file to the available stream. As discussed further below, the size of the stream may be stored as metadata.

As shown at step 1204 of FIG. 12, the file system 504 may be configured to write the data associated with the given file to memory. The memory may be, for example, system memory 116 associated with computing device 112 illustrated in FIG. 1.

As shown at step 1206 of FIG. 12, the file system 504 may be configured to send, to the storage device 508, a request for a stream identifier, the stream identifier being associated with a stream. The stream may comprise a second set of one or more erase blocks different from the first set of one or more erase blocks. For example, as illustrated in FIG. 9, the stream may comprise a single erase block, such as erase block 4. However, it is understood that a stream any comprise any number of erase blocks on the storage device 508.

As shown at step 1208 of FIG. 12, the file system 504 may receive, from the storage device 508, the stream identifier. The storage device 508 may be configured to determine an available stream based, for example, on the amount of data associated with the file to be stored in the stream, and to send to the file system 504 the stream identifier associated with that stream. Receiving the stream identifier from the storage device 508 may grant exclusive access to the stream by File A.

As shown at step 1210 of FIG. 12, the file system 504 may send, to the storage device 508, a request to write the data associated with the given file from the local memory to the stream. As shown at FIG. 9, the stream may comprise data exclusive to the given file. Sending the request to write the data associated with the given file to the stream may comprise sending, to the storage device 508, the stream identifier associated with the stream. Sending the stream identifier may instruct the storage device 508 where to write the data associated with the given file.

As further shown in FIG. 9, the file system 504 may be further configured to instruct the storage device 508 to execute a trim command on the data associated with the given file in the first set of one or more erase blocks. The trim command may inform the storage device 508 that the data inside the first set of one or more erase blocks is no longer in use and may be deleted. In response to receipt of the trim command, the storage device 508 may be configured to delete the data associated with the given file in the first set of one or more erase blocks. As discussed above, the storage device 508 may need to perform garbage collection before the data can be permanently deleted.

As discussed above, the file system 504 may maintain metadata for each file that keeps track of the location(s) of the data associated with the given file on the storage medium. This metadata may take the form of, for example, a file extent table, as shown in FIGS. 7-11. The file extent table may define, for example, an offset, a logical block address (LBA), and a length of each data range of a given file stored on the storage device. In the example of FIG. 7, the file extent table comprises data for File A. However, it is understood that the file extent table may comprise data for any number of files. Each data entry for a given file in the erase block may correspond to a page of data, such as one of pages 208 illustrated in FIG. 2. As discussed above in connection with FIG. 2, a page may be the smallest unit of the SSD 508 that can be programmed. As shown in the table of FIG. 7, two pages of data may be written to erase block 1, the pages beginning at LBA 0 and having an offset of 2. An offset may refer to the number of pages of data associated with the given file at the time of the write operation, while the length may refer to the number of consecutive pages associated with the file. As further shown in FIG. 7, a third page of data associated with File A may be written to erase block 1, the third page of data beginning at LBA 3 with an offset of 2. As shown in FIG. 8, additional write operations may be performed to the first set of one or more erase blocks. For example, a single page of data associated with File A may begin at LBA 8, two pages of data associated with File A may begin at LBA 10, and two pages of data associated with File A may begin at LBA 14.

As discussed herein, when the file system 504 determines that a threshold amount of data associated with a given file has been met, the file system may move the data from the first set of one or more erase blocks to a stream. Once the write operation is completed, the file system may update the metadata it stores for the file to reflect the change in location of the data of file A. For example, in an embodiment in which the file metadata takes the form of one or more entries in a file extents table that map byte offsets of ranges of data of the file to logical block addresses (LBA) associated with the locations of those ranges on the storage device, the LBAs for the file may be updated to reflect the new location of the data in the stream on the storage device. For example, as shown in FIG. 9, each of the pages of data associated with File A has been moved to Stream 1. Thus, the file extent table may be updated to reflect the new LBA for the ranges of data associated with File A in Stream 1. Because the ranges of data have been moved to consecutive logical addresses on the storage device in Stream 1, a single entry suffices to indicate that the data, having a length of “8” now resides starting at LBA “30” of the storage device.

As shown in FIG. 10, as additional write operations are made to File A, the file extent table may be updated to include the additional pages of data. For example, as one page of data is added to Stream 1, the file extent table may be updated to include information about the location of that additional page of data associated with File A. As shown in FIG. 11, as the threshold of Stream 1 has been reached and no new data can be written to the stream, data associated with File A may be written to another location on the storage device, such as, for example, the first set erase blocks not associated with a stream. Thus, the file extent table may be further updated to include those new entries. In the example of FIG. 11, two new pages of data associated with File A have been written to the first set of one or more erase blocks, a first page beginning at LBA 20 and a second page beginning at LBA 22.

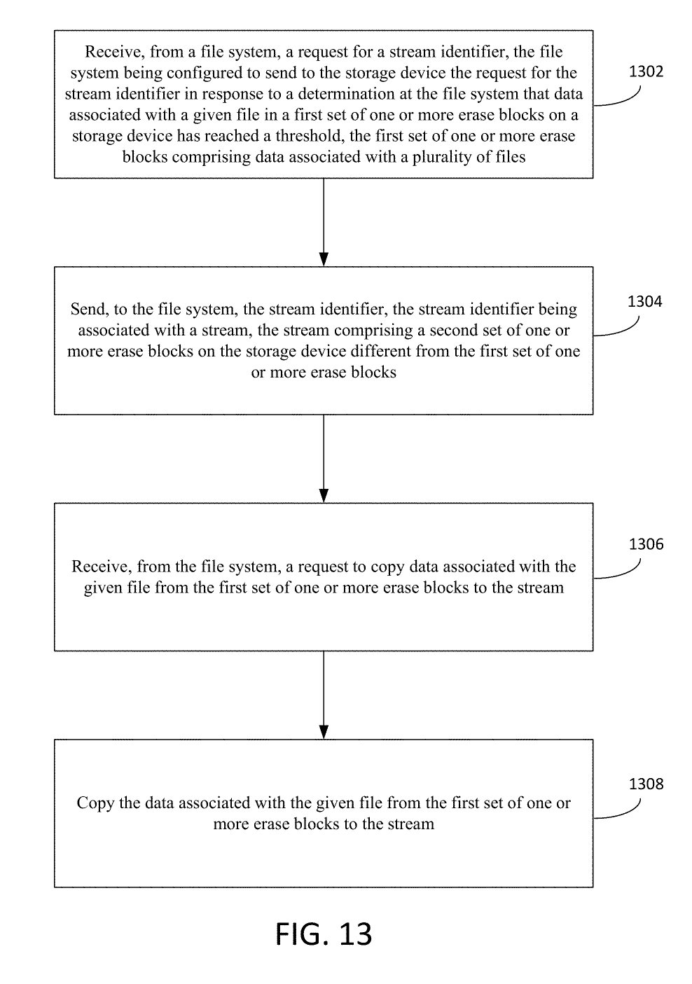

FIG. 13 illustrates a method performed by a storage device, such as SSD 508 illustrated in FIG. 5, to optimize the use of available streams on the storage device. This example may be referred to a “device managed.” For example, as shown at step 1302 of FIG. 13, the storage device 508 may be configured to receive, from a file system, a request for a stream identifier, the file system being configured to send to the storage device the request for the stream identifier in response to a determination at the file system that data associated with a given file in a first set of one or more erase blocks on a storage device has reached a threshold, the first set of one or more erase blocks comprising data associated with a plurality of files. The file system may be, for example, file system 504 illustrated in FIG. 5. The file system 504 may make a determination that the data associated with a given file in a first set of one or more erase blocks has reached a threshold based on metadata stored in the file system. As one example, the metadata may comprise a size of the stream.

As shown at step 1304 of FIG. 13, the storage device 508 may send, to the file system 5-4, the stream identifier. The stream identifier may be associated with a stream comprising a second set of one or more erase blocks on the storage device 508 different from the first set of one or more erase blocks.

As shown at step 1306 of FIG. 13, the storage device 508 may receive, from the file system 5-4, a request to copy data associated with the given file from the first set of one or more erase blocks to the stream. The request may include the stream identifier associated with the stream. As shown in the example of FIG. 9, all data associated with File A may be moved from erase blocks 1 and 2 to Stream 1. Receiving a request to copy data associated with the given file from the first set of one or more erase blocks to the stream may comprise receiving, from the file system 504, a logical block address of the data associated with the given file. In one embodiment, the storage device 508 may further be configured to update metadata in the storage device 508 to include a location of the data associated with the given file in the stream. The location may comprise a physical block address of the data associated with the given file in the stream. For example, the storage device 508 may maintain a LBA to physical block mapping table, and upon receiving the LBAs of the data associated with the given file and copying the data associated with the given file from the first set of one or more erase blocks to the stream, may update the LBA to physical block mapping table to include a new physical block address(es) of the data associated with the given file. Having the storage device update its mapping of LBAs to physical blocks alleviates the need for the file system to update its own metadata (e.g., file extents table); hence the use of the term “device managed” to describe this embodiment.

As shown at step 1308, the storage device 508 may be configured to copy the data associated with the given file from the first set of one or more erase blocks to the stream. As shown in FIG. 9, the storage device 508 may be further configured to execute a trim command on the data associated with the given file in the first set of one or more erase blocks. As discussed above, there may be less overhead associated with the example method performed by the storage device, as the file system may not need to update its file location metadata (e.g., file extent mapping table). Instead, the storage device may update the physical addresses associated with each LBA range, while maintaining the same LBAs from the viewpoint of the file system.

As discussed above, a computing device may be configured to expose a number of streams IDs for which the host (e.g., a file system) can tag write operations with. This may also be referred to as “random access streaming.” The device may determine how best to service the stream writes with the goals of reducing internal device write amplification, reducing read/write collisions, maximizing throughput, minimizing latency, etc. The device may place separate streams across separate NAND dies based on the data's lifetime such that data of the same lifetime and/or write characteristics would live and die together—thus freeing an entire erase unit at a time—and thereby reducing garbage collection.

In another embodiment, an append-only streams capability may be implemented. In connection with append-only streams, the device may expose the maximum number of inactive and active streams, erase block size, (optionally) maximum number of erase blocks that can be written in parallel, and an optimal write size of the data. An application may constrain itself to only write sequentially to an append-only stream. This may be enforced using one or more APIs. Write operations may need to be in multiples of the optimal write size. Append only streams may be crafted by requesting a write stream with a certain number of erase blocks to append to.

The following commands may be available via an application programming interface (API) to support the append-only streams capability:

Open (new stream or non-sealed stream), with options to keep stream open indefinitely until stream is full, or close prematurely if NAND timer has expired;

Close (temporarily closed—the stream may be writable after it is opened);

Seal (permanently close—i.e., the stream is read only);

Append;

Update (the device can optionally support update in place at the cost of write amplification);

Read;

Trim;

Secure Erase;

Query write pointer;

Query stream size; and

Query writable space remaining in stream.

In one aspect, a stream may not be kept open indefinitely due to physical constraints on the NAND. However, an append only stream may optionally be kept open indefinitely where the device will append a minimal amount of filler data to satisfy minimal NAND cell charge needs. When the host reads the data, the SSD may optionally truncate the namespace of the stream or the device, and skip over the areas which have been internally tracked as filler data, returning only valid data. Alternatively, the SSD may return a well known pattern of filler data. In one example, the file system should be able to hide this filler data from application that are using files on the file system. In another example, the application may be told that filler data is being returned.

When an append operation is executed, it may be possible that the operation is only partially completed. In this example, the number of bytes appended and a status code indicating one or more reasons why the append was not completed (e.g., generic errors, insufficient space to append due to media errors, filler space taken up by keeping stream open, etc.) may be returned to the device.

Host devices typically interact with storage devices based on logical block address (LBA) mappings to read/write data. File systems may maintain metadata to present application/user-friendly access points known as files which may be accessed by file name/ID & an offset. When reading/writing to or from a block-addressed device, the host may specify a LBA mapping (e.g., a starting block and length). When reading/writing to or from a stream-addressed device, the host may specify a stream ID and optionally an offset and length. In one exmaple, the offset may be located within the stream.

A file system may interact with streaming devices using different operating modes. For example:

For a device with no streams, a block addressed operating mode may be used;

For a device with random-access streams, a block addressed operating mode may be used;

For a device with one or more random-access streams and all other streams are append-only, a block-addressed operating mode may be used;

For a device with one or more random-access streams which are block-addressed in one namespace and in another namespace all streams are append-only, the append-only streams may be stream addressed;

For a device with all append-only streams, a block addressed operating mode may be used; and

For a device with all append-only streams, a stream-addressed operating mode may be used.

In one aspect, based on the NAND technology, NAND pages may have a limit to the amount of lifetime writes that they can accept before their electrical signal is too weak to persist data for a sufficient duration. There may be complex algorithms internally to spread-out the wear, known as “wear levelling,” that involve reading a large amount of data into memory, finding a free space to write it, and erasing the old data. Erase units may be significantly larger than the program unit, thus the device may need to be intelligent on selection to minimize the amount of data that is “over read.”

Reading data may reduce the electrical charge within a NAND cell, and over time the charge may drop to low enough levels that put the data at risk of permanent loss. The device may internally maintain a mapping of the voltages and rewrite/refresh the data as-needed. This may consume write cycles and internal bandwidth.

In one aspect, a file system can use stream semantics to read/write user data, maintain file system metadata in at least one of its own append only stream, in a random access stream, or on a block-addressed portion of the namespace. The file system may be flexible to manage the relationship between append only streams and files, where an append only stream can be mapped to one or multiple files, or vice-versa. Files or objects managed by the file system may have data “pinned” to one or more append only streams as needed, where new allocations would only occur within those streams. The file system may seamlessly manage portions of files which are stream-addressed and block-addressed, presenting a consistent view to the front-end.

In one aspect, append only streams may be flexible entities and the file system can take advantage of that property by optionally choosing to create an append only stream which stripes across all of the available dies to maximize throughput, create append only streams which only utilize half of the available dies to reduce interference, and/or create append only streams which only use a single die to maximize writable capacity due to media defects or errors.

The file system may support front-end random-write access to an append only stream by converting that access to appends in an append only stream. Any writes to previous data will effectively create “holes” in the append only stream of invalid data, and updates may appended to the append only stream.

The file system may perform garbage collection of streams when the amount of invalid data within the stream exceeds internal thresholds and/or upon admin/application initiated triggers. This may comprise reading the data of the old stream, transforming it in memory (typically to coalesce data), and then writing it to a new stream. The actual data movement can also be offloaded to reduce host-device IO activity.

The file system may support flexible extent sizing to better cooperate with the structure of the underlying flash. The extent sizes may be shrunk if needed to handle errors.

The file system may deal with errors encountered when appending to a stream by sealing its extent early and abandoning it, re-writing it to another stream, or treating the already-written data as valid. This may be referred to as “fast-fail.” Instead of the device performing extraordinary means to satisfy the write or performing its own re-allocations, the device may simply give up quickly to allow for the system to quickly recover and send the write elsewhere. This may reduce typical recovery that can take on the order of seconds, which is impactful to a cloud-scale system. Thus, it may be desirable to quickly abandon the task and try elsewhere.

In one aspect, the file system can participate in keeping NAND blocks/streams open for a period of time for writing related data, instead of having the device close them after a timer has elapsed. When the device operates in this mode, it may independently write sufficient filler data to keep the block open to satisfy voltage requirements. The device may then advance the write pointer and track how much data is remaining in the stream or block. The file system may write the filler data, or the device can write the filler data and track the garbage region. The file system may either identify the filler data when reading and skip over it (changing the run table mapping), or the device can truncate the stream and automatically skip over the data when reading.

The file system may receive information from the underlying NAND cells on the voltage health state, either in the form of vendor-specific predictive failure data, or in raw voltage data with vendor-specific threshold information. With this information, the file system may make determinations when/if garbage collection is needed to prevent the data from being destroyed. Voltages can drop slowly over time, upon heavy over-read activity, or after the device is powered off for a period of time.

The file system may choose to abandon the data instead of performing garbage collection if for instance the data is no longer needed (e.g., due to overwrites) or there are sufficient copies maintained in another device. Typically, the device may be configured to always perform garbage collection when the voltage sags sufficiently low. This however is not always needed.

The file system may have better knowledge of the nature of the data than the underlying device, and thus it can perform larger units of garbage collection or coalescing than NAND can, which typically does this in units of the erase unit. Overall, this reduces the amount of write amplification that is needed to maintain the health of the NAND due to voltage sag.

Instead of the file system performing the read and rewrite of the data, it may optionally offload this operation to the device by specifying a new stream to write the data to, or another existing stream to append the data to. This may cover other offload data operations such as coalescing, trim, etc.

In one aspect, when a file system is operating on a stream based device, it may abstract an LBA interface on top of the stream device to support applications which are not aware of stream based addressing.

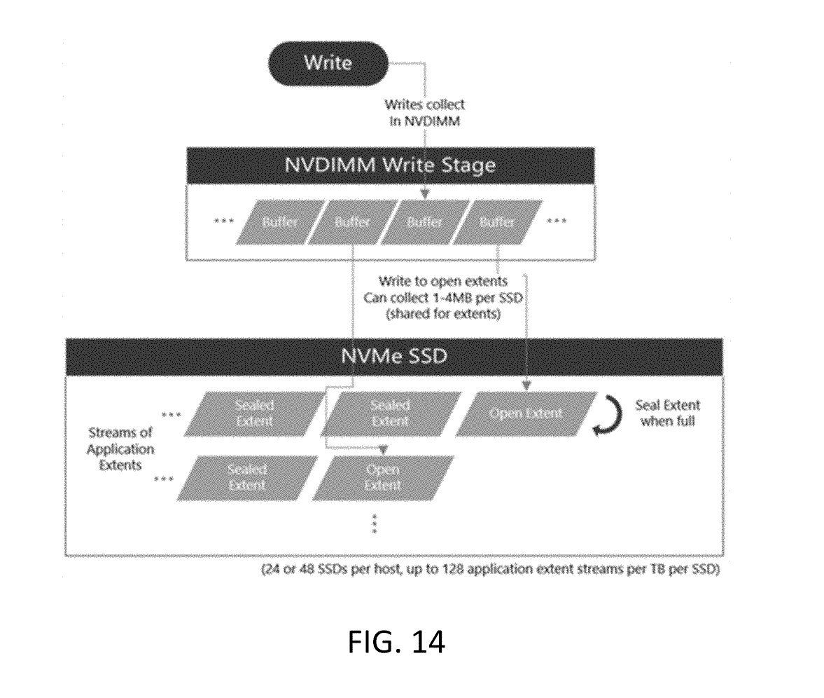

In another embodiment, an append only system may be utilized with primary storage on an SSD, including a small NVDIMM write stage. Data may be organized in streams of extents, with all extents being sealed and read-only except the last one that is active for appends. As shown in FIG. 14, the NVDIMM write stage may allow the system to collect small (e.g., 4-64 kb) user writes and then destage as large sequential writes (e.g., 1 MB) to the SSDs on a per-extent basis. When sufficient data within application data extents have been invalidated, valid data may be garbage collected by the host to a new extent, and the old extent may be trimmed as a whole. This process may be the responsibility of the host. The application may support data extents of variable sizes, with typical extent sizes being 256 MB.

Write amplification of the SSDs can be nearly eliminated by matching application data extent size to the SSD's unit of garbage collection by tailoring data extents to be a multiple of the erase block size. Flexible throughput of the application data extents can be obtained by controlling the number of erase blocks to stripe against (e.g., can stripe against all dies, or can stripe against a smaller number of blocks). As the workload may be append only, metadata for stream mapping may be minimized. Thus, the SSD may only need to track a list of blocks and maintain an internal write pointer where the next host appending writes will occur.

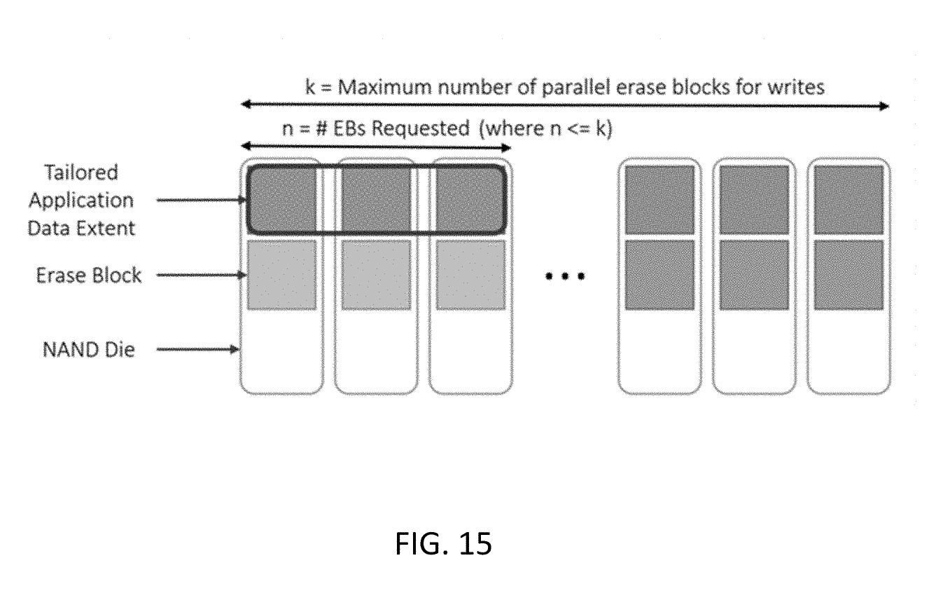

As shown in FIG. 15, one or more of the following may be required:

An optimal write size per erase block. This may be the smallest unit of erase within an erase block that does not cause a read-modify-write within the drive (e.g., this may be the flash page size);

Erase block size (may be the minimal optimal trim unit);

Maximum number of parallel erase blocks for writes. This may be the minimum number of parallel units (e.g., the number of dies);

A new append only stream directive type;

A new stream directive operating mode for append only streams; and

A maximum number of append only streams/TB.

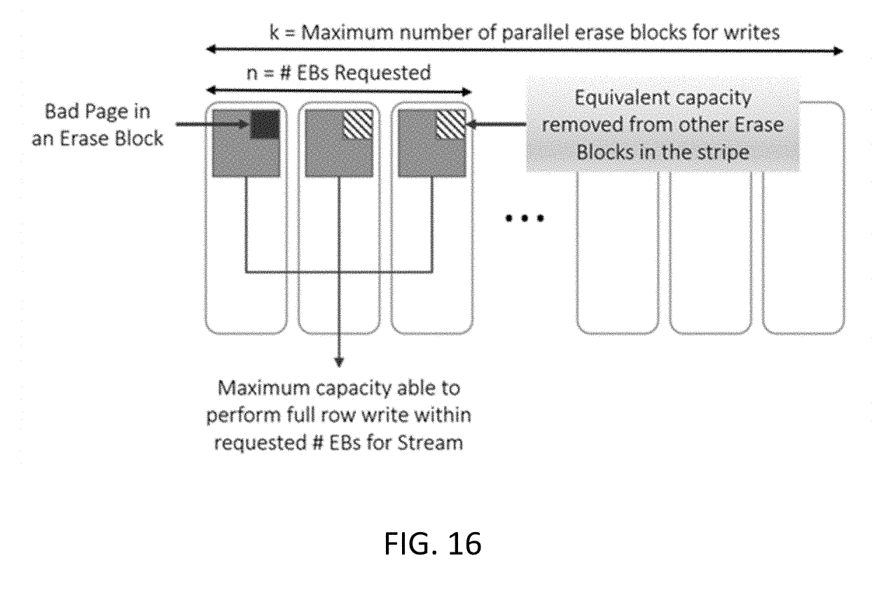

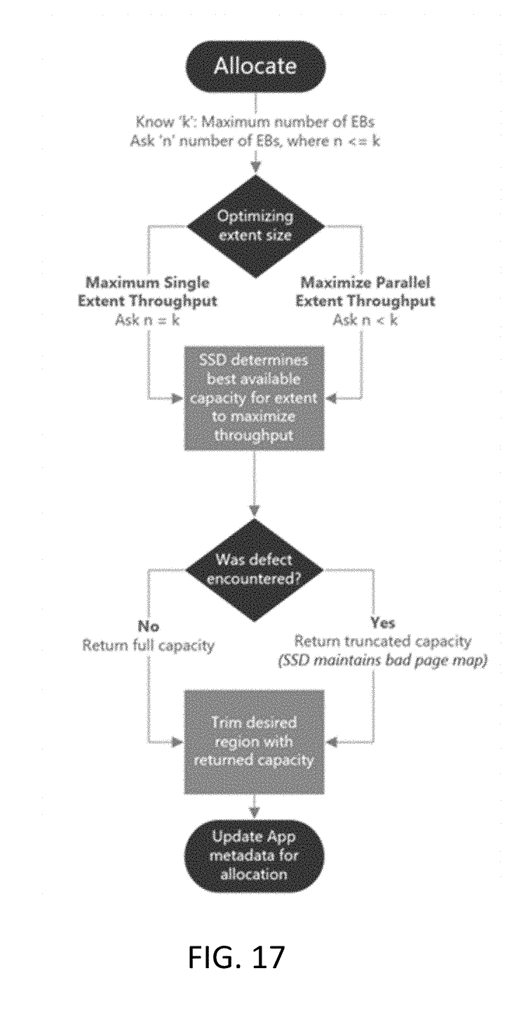

As shown in FIG. 16 and FIG. 17, it may be desirable to tailor the application data extent to guarantee optimal performance across the requested erase blocks. It may not always be desirable to write across the maximum number of erase blocks. When there is a defective page, capacity from other erase blocks in the stream may be truncated. The device may mark an entire erase block if needed, in which case the device may need to choose other healthy erase blocks.

In one example, the device may shrink the stream size due to a defect. The device may also shrink the stream size in order to prevent a corruption of the data. If the flash block is left open, the most recently written data may be corrupted. To prevent this, the device can pad out a few pages with dummy data and shrink the size of the block. This is helpful because there is a lot of information the device must use to determine when and how much dummy data to write. With this mechanism in place, the device and user may not have to exchange all this information.

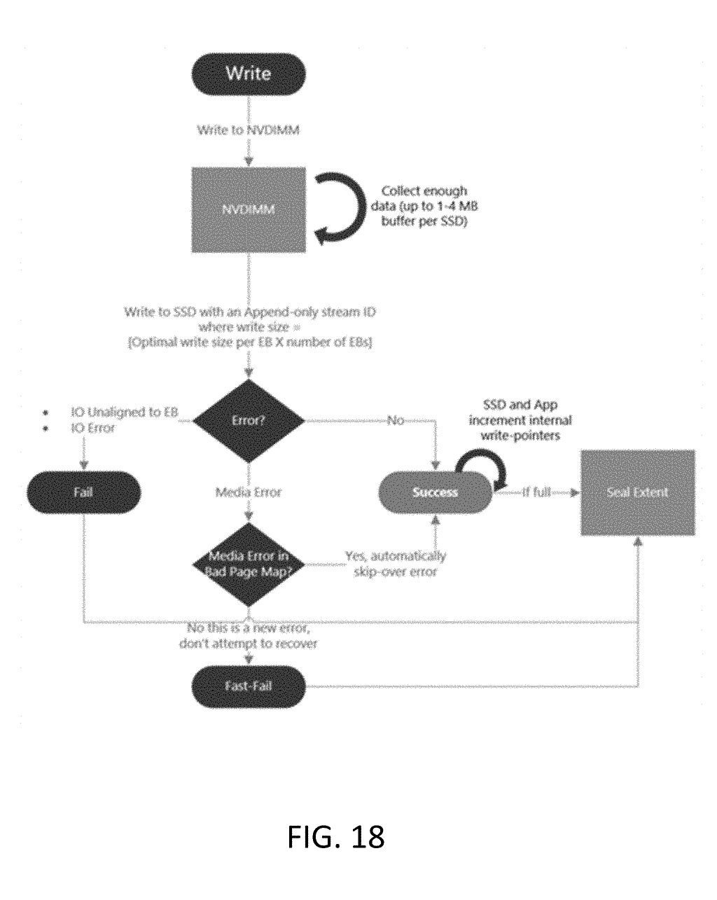

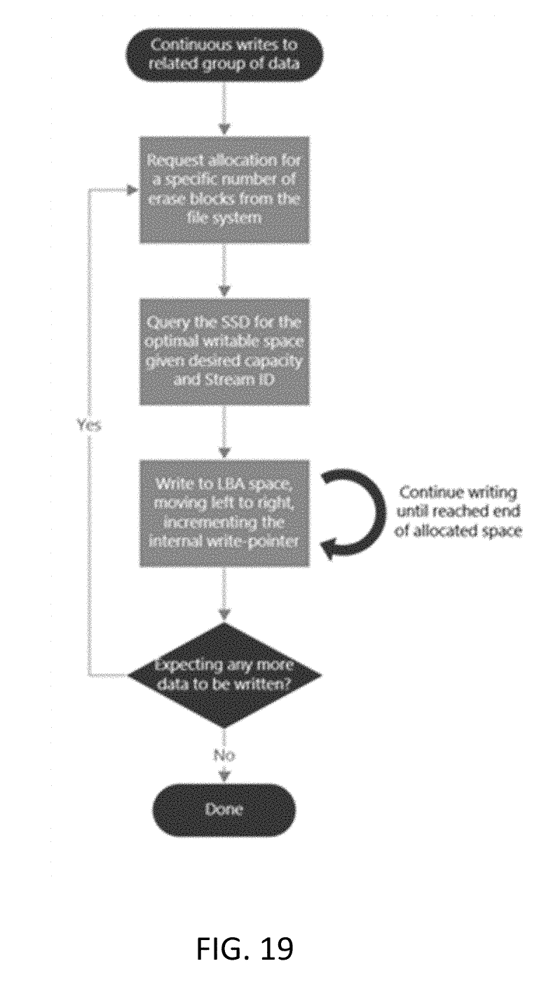

As illustrated in FIG. 18 and FIG. 19, an example workflow for writing to an open extent may be as follows:

At step 1, a host may send writes with a service time maximum (e.g., a proposed fast fail mechanism);

At step 2, all writes may be of the same size to maximize throughput across the desired erase blocks, where the write size may be equal to the optimal write size per erase block multiplied by the maximum number of erase blocks assigned to the application data extent at allocation time. However, writes may be sized flexibly to maximize throughput across the desired erase blocks where the write size may be equal to a multiple of the optimal write size per erase block multiplied by the number of erase blocks assigned to the stream or application data extent;

At step 3, all writes within an erase block may be sequential appends;

At step 4, if either step 2 or step 3 is not satisfied, or the write failed, fast-fail the write operation;

At step 5, when new media errors are encountered within the erase block, the device may attempt to remap with pages from the reserve area in the same erase block if and only if the IO timeout maximum will not be exceeded for the entire command (remapping and write). Otherwise, do not attempt to remap or error correct, and fast-fail the write;

At step 6, for known media errors established in the base page map at the time of extent allocation, sector slip.

New characteristics may be exposed to help better align data extents and write patterns with NAND erase blocks and page access. A single firmware image may switch modes between NVMe directives streams and append only streams.

A new command may be configured to prepare an append only stream for writes. This command may be called by the host when allocating a new application data extent, where one or more application extents are mapped to a stream. The input may comprise the number of erase blocks to write across and the stream ID to write to, and the maximum number of writable space when writing striped across the desired number of erase blocks (accounting for page defects) may be returned. In one example, when writing in append only mode, a minimum of 128 streams/TB and two random access streams may be provided. Support may also be provided for implicit opens of streams.

The illustrations of the aspects described herein are intended to provide a general understanding of the structure of the various aspects. The illustrations are not intended to serve as a complete description of all of the elements and features of apparatus and systems that utilize the structures or methods described herein. Many other aspects may be apparent to those of skill in the art upon reviewing the disclosure. Other aspects may be utilized and derived from the disclosure, such that structural and logical substitutions and changes may be made without departing from the scope of the disclosure. Accordingly, the disclosure and the figures are to be regarded as illustrative rather than restrictive.

The various illustrative logical blocks, configurations, modules, and method steps or instructions described in connection with the aspects disclosed herein may be implemented as electronic hardware or computer software. Various illustrative components, blocks, configurations, modules, or steps have been described generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the present disclosure.

The various illustrative logical blocks, configurations, modules, and method steps or instructions described in connection with the aspects disclosed herein, or certain aspects or portions thereof, may be embodied in the form of computer executable instructions (i.e., program code) stored on a computer-readable storage medium which instructions, when executed by a machine, such as a computing device, perform and/or implement the systems, methods and processes described herein. Specifically, any of the steps, operations or functions described above may be implemented in the form of such computer executable instructions. Computer readable storage media include both volatile and nonvolatile, removable and non-removable media implemented in any non-transitory (i.e., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computer.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

The description of the aspects is provided to enable the making or use of the aspects. Various modifications to these aspects will be readily apparent, and the generic principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed:

1. A method comprising:
determining a size of one or more related groups of data;
determining a size of one or more erase blocks in a file system;
requesting, from the file system, one or more stream identifiers based on the size of the one or more related groups of data and the size of the one or more erase blocks;
requesting, from a solid state device and using the one or more stream identifiers, an optimal writable space on the solid state device; and
writing data to the optimal writable space on the solid state device.
